(19) United States
(12) Patent Application Publication
(10) Pub. No.: US 2014/0338318 A1
(43) Pub. Date: Nov. 20, 2014

(54) MULTIPLE CAVERN COMPRESSED AIR ENERGY STORAGE SYSTEM AND METHOD

(71) Applicant: Chamisa Energy Company, LLC, Santa Fe, NM (US)

(72) Inventor: Alissa Oppenheimer, Santa Fe, NM (US)

(21) Appl. No.: 14/005,074

(22) PCT Filed: Apr. 5, 2013
(86) PCT No.: PCT/US2013/035446

§ 371 Date: Sep. 13, 2013

Related U.S. Application Data
(63) Continuation of application No. 13/833,000, filed on Mar. 15, 2013, now abandoned.
(60) Provisional application No. 61/621,232, filed on Apr. 6, 2012.

(51) Int. Cl. F01D 15/10; H02J 15/00

(52) U.S. Cl. CPC F01D 15/10; H02J 15/006; F05D 2260/42
USPC 60/398

(57) ABSTRACT

An energy system for storing pressurized air and utilizing the pressurized air to generate electricity includes a first storage cavern, a second storage cavern, an air compressor in fluid communication with the first and second storage caverns, an electric generating mechanism, a combustion chamber, a controller and a recuperator. The air compressor is in fluid communication with a compressor piping system, the electric generating mechanism and the combustion chamber are in fluid communication with a generator piping system and the recuperator is in fluid communication with an exhaust piping system and the generator piping system. The controller is configured to operate the energy system such that the compressor directs compressed an into the first storage cavern through the compressor piping system at the same time the electric generating mechanism generates electricity utilizing at least compressed air from the second cavern.

### CROSS-REFERENCE TO RELATED APPLICATIONS

The present application claims the benefit of U.S. patent application Ser. No. 13/833,000, filed Mar. 15, 2013 and U.S. Provisional Patent Application No. 61/621,232, filed on Apr. 6, 2012, both titled “Multiple Cavern Compressed Air Energy. Storage System and Method” the entire contents of which are incorporated herein by reference in their entirety.

### BACKGROUND OF THE INVENTION

Compressed Air Energy Storage (CAES) involves the storage of compressed air, typically in a large volume, for use at another time CAES systems typically utilize off-peak (low-cost) electrical power to compress air, the compressed air is stored in a storage vessel and the stored, compressed an is used at a later time to generate electricity during peak (high-price) electric usage times. CAES systems have been utilized to power various mechanism.

The CABS system may store the compressed air in a relatively large volume vessel, potentially an underground cavern, for later use of the compressed air to generate electricity. These CAES systems generally utilize a single cavern to store the compressed air and later draw the compressed air from the single cavern to generate electricity. These single cavern systems suffer from a limited volume of compressed air storage space, the inability to introduce compressed air into the cavern and withdraw compressed air from the cavern at the same time, shutdown of the system for malfunctions with the cavern or maintenance on the cavern and its related hardware or similar limitations resulting from the single cavern design. A further consequence of the single-cavern design is that the conversion process (energy to compressed air, or compressed air to energy) is unidirectional. The two functions cannot be performed at the same time, thus limiting the utility of the system for storage, generation and grid-balancing.

In addition, CAES systems that may include multiple air storage mechanisms or vessels often have a high pressure vessel and a low pressure vessel that are connected in series to each other. This arrangement also results in the inability to pressurize one of the vessels at the same time as air from a second vessel is utilized to generate electricity. These multiple cavern conventional CAES systems limit the ability to operate a compressor utilizing alternatively generated electricity from, for example, solar panels on a hot sunny day in the summer, to compress air and store the air in a vessel, while at the same time using previously pressurized and stored air from a second vessel to drive a generator and produce power. Peak performance for certain alternatively energy generators may coincide with peak power requirements of an electrical system and a CABS system that does not permit storing energy at the same time as previously stored energy is utilized to address peak power needs is disadvantageous.

The preferred multiple cavern or vessel CABS system addresses the limitations of the previous CABS systems by employing an efficient overall system for producing power utilizing stored air pressure from underground caverns.

### BRIEF SUMMARY OF THE INVENTION

Briefly stated, in a preferred embodiment, an energy system for storing compressed air and utilizing the compressed air to generate electricity includes, a first storage cavern and a second storage cavern. The second storage cavern is separate from the first storage cavern. An air compressor is in fluid communication with the first and second storage caverns. The air compressor is driven by electricity from an alternative energy generator or off-peak electrical energy to provide pressurized air to the first and second caverns. An electric generating mechanism is in fluid communication with the first and second storage caverns. The electric generating mechanism generates electricity utilizing the compressed air from the first and/or second cavern(s), typically during peak electric usage periods.

In another aspect, a preferred energy system is utilized for storing pressurized air and using the pressurized air to generate electricity. The energy system includes a first storage cavern and a second storage cavern separate from the first storage cavern. An air compressor is in fluid communication with the first and second storage caverns through a compressor piping system. The air compressor is configured to provide pressurized air to the first and second caverns through the compressor piping system. An electric generating mechanism is in fluid communication with the first and second storage caverns through a generator piping system. The compressor piping system is separate from the generator piping system. A combustion chamber is in fluid communication with the generator piping system and is located upstream of airflow relative to the electric, generating mechanism. The combustion chamber is configured to preheat the pressurized air flowing to the electric generating mechanism. A controller is in communication with the air compressor, the electric generating mechanism, the compressor piping system and the generator piping system. The controller is configured to operate the energy system such that the compressor directs compressed air into the first storage cavern through the compressor piping system at the same time the electric generating mechanism generates electricity utilizing at least compressed air from the second cavern. A recuperator is in fluid communication with the electric generating mechanism through an exhaust piping system. The exhaust piping system includes an exhaust and is separate from the generator piping system and the compressor piping system. The recuperator is configured to transfer heat energy from exhaust air of the electric generating mechanism to the generator piping system.

In yet another aspect, a preferred energy system includes a controller for use in the energy system. The controller is adapted to be in communication with an air compressor, an electric generating mechanism, a compressor piping system, a generator piping system, a recuperator and a plurality of valves associated with the compressor piping system and the generator piping system. The controller is configured to operate the energy system such that the compressor directs compressed air into a first storage cavern through the compressor piping system at the same time the electric generating mechanism generates electricity utilizing at least compressed air from a second storage cavern.

### BRIEF DESCRIPTION OF THE SEVERAL VIEWS OF THE DRAWINGS

The foregoing summary, as well as the following detailed description of the invention, will be better understood when read in conjunction with the appended drawing. For the purpose of illustrating the invention, there is shown in the drawing an embodiment which is presently preferred. It should be understood, however, that the invention is not limited to the precise arrangements and instrumentalities shown. In the drawings:

FIG. 1 is a perspective, partial cross-sectional view of a multiple cavern compressed air energy storage system in accordance with a preferred embodiment of the present application; and

FIG. 2 is a block diagram of the multiple cavern compressed air energy storage system of FIG. 1.

### DETAILED DESCRIPTION OF THE INVENTION

Certain terminology is used in the following description for convenience only and is not limiting. Unless specifically set forth herein, the terms “a”, “an” and “the” are not limited to one element but instead should be read as meaning “at least one”. The words “right,” “left,” “lower,” and “upper” designate directions in the drawing to which reference may be made. The words “inwardly” or “distally” and “outwardly” or “proximally” may refer to directions toward and away from, respectively, the geometric center or orientation of the device and related parts thereof. The terminology includes the above-listed words, derivatives thereof and words of similar import.

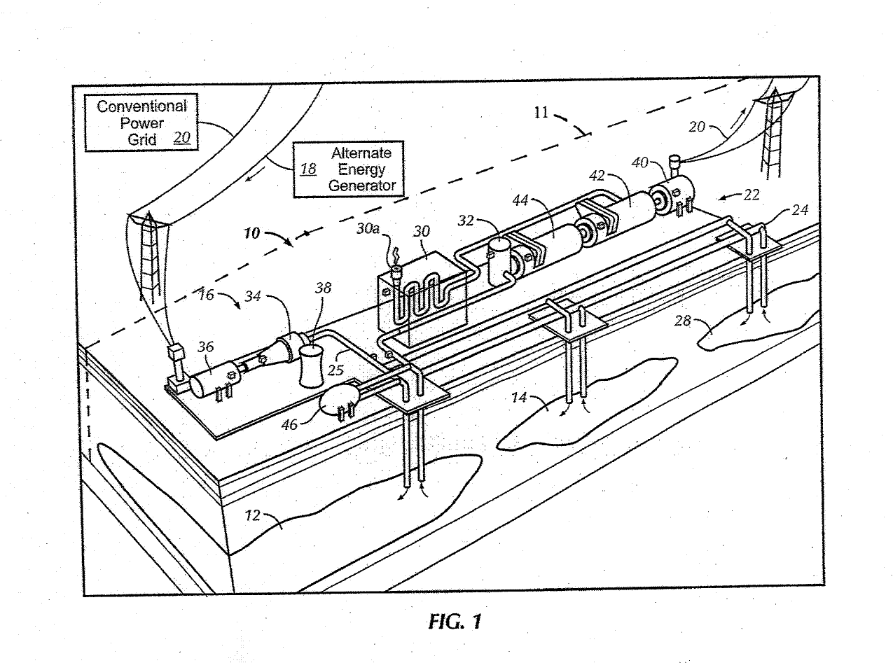

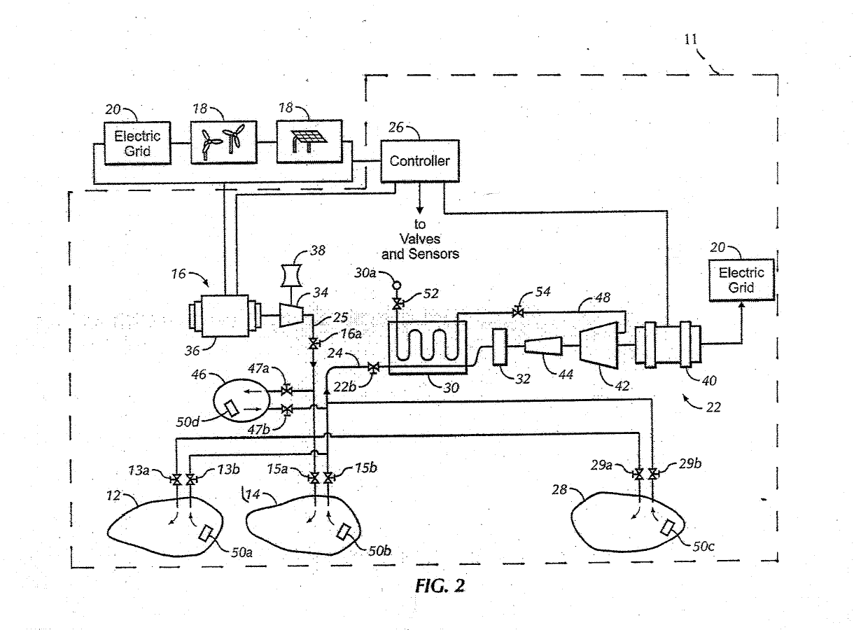

Referring to FIGS. 1 and 2, the present application is directed to an energy system, generally designated 10, for storing pressurized air to generate electricity. The energy system includes a first storage cavern 12 for storing the compressed air and a second storage cavern 14 separate from the first storage cavern 12. The second storage cavern 14 is also used for storing compressed air. An air compressor 16 is in fluid communication with the first and second storage caverns 12, 14. The air compressor 16 is preferably driven by electricity from an alternative energy generator 18 or off-peak electrical energy, preferably from a conventional power grid 20, to provide pressurized air to the first and second caverns 12, 14.

An electric generating mechanism 22 is also in fluid communication with the first and second storage caverns 12, 14. The electric generating mechanism 22 is preferably in fluid communication with the first and second storage caverns 12, 14 through a generator piping system 24. The generator piping system 24 preferably includes several control valves 13b, 15b, which will be described in greater detail below, to selectively open and/or close flow of pressurized air from the first and second storage caverns 12, 14 to the electric generating mechanism 22. In addition, the air compressor 16 is preferably in fluid communication with the first and second storage caverns 12, 14 through a compressor piping system 25. The compressor piping system 25 also preferably includes control valves 13a, 15a, which will be described in greater detail below, to selectively open and/or close the flow of pressurized air from the air compressor 16 to the first and second storage caverns 12, 14. The compressor piping system 25 is preferably separate from the generator piping system 24 such that the flow of pressurized air from the air compressor 16 and to the electric generating mechanism 22 can proceed independently of each other.

A controller 26 is preferably utilized to control the preferred system 10, including the various valves 13a, 13b, 15a, 15b, to operate the various components, including controlling flow of pressurized air to the electric generating mechanism 22 and from the air compressor 16 to and from the first and second storage caverns 12, 14, respectively. The electric generating mechanism 22 generates electricity utilizing at least the compressed air from the first cavern 12 and/or the second cavern 14. The controller 26 preferably controls the generation of pressurized air and electricity such that air is pressurized during off-peak times and electricity is generated during peak usage hours from the compressed or pressurized an that was pressurized during off-peak electric usage times or by the alternate energy generators 18. Through this type of control, profits and efficiency can be maximized by storing energy while operating expenses are low and producing energy while demand is high. Profits and efficiency can also be maximized by producing energy with the alternative energy generator 18 when the alternative energy if available for production, regardless of whether demand on the electric grid 20 is high or low.

The controller 26 is in communication with the air compressor 16, the electric generating mechanism 22, the compressor piping system 25, and the generator piping system 24. The controller 26 is configured to operate the energy system 10 such that the compressor directs compressed air into the first storage cavern 12 through the compressor piping system 25 at the same time the electric generator mechanism 22 generates electricity utilizing at least compressed air from the second cavern 14. The preferred controller 26 is able to constantly generate compressed air using the compressor 16, which is preferably driven by off-peak electricity from the electric grid 20 or alternatively generated electricity from an alternative energy generator 18, and at the same time produce electricity utilizing the electric generating mechanism 22, which is driven at least partially by compressed air from the storage caverns 12, 14. The controller 26 may also individually operate the compressor 16 to produce pressurized air for introduction into the caverns 12, 14, such as during off-peak electric utilization on the electric grid 20 or when the alternative electric generator 18 is operating, while at the same time the electrical generating mechanism 22 is shut down and not producing electricity. In addition, during high electric grid 20 utilization or peak hours and when the alternative electric generator 18 is not producing power, the controller 22 is able to produce power from the compressed air stored in the caverns 12, 14 when the air compressor 16 is not operating.

In the preferred embodiment, the system 10 also includes a third storage cavern 28. The first, second and third storage caverns 12, 14, 28 are preferably comprised of underground caverns that are generally air tight for a reasonable amount of time and relatively large such that a significant volume of compressed air may be stored in the caverns 12, 14, 28 without excessive loss of air pressure due to leakage from the caverns 12, 14, 28. The third storage cavern 28 is preferably in fluid communication with the air compressor 16 through the compressor piping system 25 and the electric generating mechanism 22 through the generator piping system 24. The system 10 is not limited to the inclusion of the first, second and third caverns 12, 14, 28 or to these caverns being underground caverns 12, 14, 28. The system 10 may alternatively include above-ground pressurized air storage, such as a fourth storage cavern or vessel 46, which is described in greater detail below, or alternative underground pressure vessels (not shown) for storing the pressurized air, including many more storage caverns than those shown in the appended figures. In addition, the system 10 is not limited to inclusion of the first, second and third storage caverns 12, 14, 28 and may include only the first storage cavern 12 and/or second storage cavern 14 for storage of the pressurized air and operation of the preferred system 10.

The preferred energy system 10 also includes a compressor valve 16a, a first cavern inlet valve 13a, a second cavern inlet valve 15a, a third cavern inlet valve 29a, a fourth cavern or vessel inlet valve 47a, a generator valve 22b, a first cavern outlet valve 13b, a second cavern outlet valve 15b, a third cavern outlet valve 29b and a fourth cavern or vessel outlet valve 47b. The controller 26 is preferably able to control the opening and closing of the valves 16a, 13a, 15a, 29a, 47a, 22b, 13b, 15b, 29b, 47b to efficiently operate the system 10. The first, second, third and fourth cavern inlet valves 13a, 15a, 29a, 47a and the compressor valve 16a are associated with the compressor piping system 25 and the first, second, third and fourth cavern outlet valves 23b, 15b, 29b, 47b and the generator valve 22b are associated with the generator piping system 24. The energy system 10 is not limited to inclusion of each of the preferred valves 16a, 13a, 15a, 29a, 47a, 22b, 13b, 15b, 29b, 47b and may include more or less valves associated with the compressor, generator and/or exhaust piping systems 25, 24, 48. The compressor valve 16a and the first, second, third and fourth cavern inlet valves 13a, 15a, 29a, 47a are preferably opened by the controller 26 to allow pressurized air to selectively flow into the first, second, third and fourth caverns or vessels 12, 14, 28, 46, respectively. Likewise, the generator valve 22b and/or the first, second, third and fourth cavern outlet valves 13b, 15b, 29b, 47b are preferably opened by the controller 26 to selectively allow pressurized air to flow from the first, second, third and/or fourth caverns or vessel 12, 14, 28, 46 into the electrical generator mechanism 22 to generate electricity.

The creation, modification, improvement and/or use of the multiple subsurface storage caverns 12, 14, 28 and the vessel 46 is preferred, as this design allows for a degree of operational flexibility that is preferred over existing power generation resources. The multiple subsurface storage caverns 12, 14, 28 and the vessel 46 enable the simultaneous depletion and filling of the various storage caverns 12, 14, 28 and the vessel 46 with pressurized air in a single facility or system 10. This, in turn, enables the preferred system 10 to respond to the electric energy market in both real-time and day ahead scenarios and operational conditions. In addition, the utilization of the underground storage caverns 12, 14, 28 and the vessel 46 utilizes the storage capacity of the caverns 12, 14, 28 and the vessel 46 to promote relatively safe storage of a large volume of pressurized air. The storage caverns 12, 14, 28 and the vessel 46 are preferably located on the same site or parcel of property 11 as the air compressor 16, the electric generating mechanism 22, a combustion chamber 32 and a recuperator 30, which are each components of the preferred energy system 10. Maintaining the underground storage caverns 12, 14, 28 and/or the vessel 46 on the same site 11 promotes efficient utilization of the system 10 by limiting pressure losses in the piping systems 24, 25 and facilitating quick production of electrical energy with the electric generating mechanism 22. Close proximity or positioning of the underground storage caverns 12, 14, 28 and/or the vessel 46 beneath or immediately adjacent relative to the electric generating mechanism 22 promotes quick response in providing pressurized air to the electric generating mechanism 22. Quickly providing pressurized air to the electric generating mechanism 22 permits the preferred system 10 to promptly address fluctuations in draw on the electric grid 20, by quickly providing supplemental power to the electric grid 20 during peak demand or spikes in demand. In the preferred system, at least portions of the preferred underground storage caverns 12, 14, 28 are positioned directly beneath or below the site or facility 11 that houses the electric generating mechanism 22 and the air compressor 16.

The flexibility and responsiveness of the preferred system 10 that utilizes the multiple storage caverns 12, 14, 28 and the vessel 46 also makes it possible for a facility to simultaneously act as both a controllable load and a generation resource. Accordingly, the preferred system 10 can provide an array of power products, including ancillary services, as well as peaking, intermediate and base load energy. The preferred system 10 is also flexible in that air pressure may be loaded into the caverns 12, 14, 28 and the vessel 46 independently or at the same time as the pressurized air in others of the caverns 12, 14, 28 and the vessel 46 is utilized to generate electricity with the generator 22.

The preferred energy system 10 also includes the recuperator 30 positioned between the storage caverns 12, 14, 28 and the vessel 46 and the electric generating mechanism 22 in the generator piping system 24. The recuperator 30 is also in fluid communication with the electric generating mechanism 22 through an exhaust piping system 48 on the exhaust side of the electric generating mechanism 22. The exhaust piping system 48 is separate from the generator piping system 24 and the compressor piping system 25. The recuperator 30 preferably transfers heat energy from exhaust air of the electric generating mechanism 22 that is flowing through the exhaust piping system 48 to intake air from the storage caverns 12, 14, 28 in the generator piping system 24 that is entering the electric generating mechanism 22. The recuperator 30 improves the efficiency of the system by recycling the heat in the exhaust air flowing through the exhaust piping system 48 back into the air flowing through the generator piping system 24 by pre-heating the intake air flowing into the electric generating mechanism 22. Once the heat from the exhaust air is transferred to the intake air, the cooled air is exhausted from an exhaust pipe 30a of the recuperator 30.

The preferred system 10 also includes the combustion chamber 32 in communication with the generator piping system 24 and upstream of airflow relative to the electric generating mechanism 22. The combustion chamber 32 is configured to preheat the pressurized air flowing to the electric generating mechanism 22. The combustion chamber 32 is preferably positioned between the recuperator 30 and the electric generating mechanism 22 such that the pressurized air flowing into the combustion chamber 32 is preheated by the recuperator 30 prior to entering the combustion chamber 32. In the preferred embodiment, the combustion chamber 32 is a natural gas fueled combustion chamber 32 that heats the intake gas flowing out of the recuperator 30 before the pressurized and heated gas flows into and through the electric generating mechanism 22. The combustion chamber 32 is not limited to being natural gas fueled and may be comprised of nearly any variety of combustion chamber 32 that is fueled by nearly any variety of fuel for combustion, as would be apparent to one having ordinary skill in the art based upon the present disclosure.

The air compressor 16 of the preferred embodiment includes a compressor 34 and a motor 36. The motor 36 is preferably powered by off-peak electricity from the conventional power grid 20 or the alternate energy generator 18, such as a solar farm, wind farm, hydroelectric power, biofuel facilities, and like alternative energy generators 18. A water cooling tower 38 is preferably associated with the compressor 34 to cool the compressor 34 during operation, but is not limiting and the compressor 34 may operate without the water cooling tower 38 without significantly impacting the operation of the preferred multiple cavern energy system 10.

In one preferred energy storage system 10, the first underground storage cavern 12 and the second underground storage cavern 14 are separate from each other. The first and second underground storage caverns 12, 14 are located on a commonly owned parcel of property or site 11. The air compressor 16 is in fluid communication with the first and second underground storage caverns 12, 14 through the compressor piping system 25 and the air compressor 16 is configured to provide pressurized air to the first and second underground storage caverns 12, 14 through the compressor piping system 25. The electric generating mechanism 22 is in fluid communication with the first and second underground storage caverns 12, 14 through the generator piping system 24 and the compressor piping system 25 is separate from the generator piping system 24. The controller 26 is in communication with the air compressor 16, the electric generating mechanism 22, the compressor piping system 25 and the generator piping system 24. The controller preferably operates the energy system 10 such that the compressor 16 directs compressed air into the first underground storage cavern 12 through the compressor piping system 25 at the same time the electric generating mechanism 22 generates electricity utilizing at least compressed air from the second underground storage cavern 14. The air compressor 16 and the electric generating mechanism 22 are located on the parcel of property 11. Locating the first and second caverns 12, 14, the air compressor 16 and the electric generating mechanism 22 on the same commonly owned site or parcel of property 11, permits the owner to control the property 11 and system 10, generally without other property owner interference. In addition, locating the first and second caverns 12, 14, the air compressor 16 and the electric generating mechanism 22 on the same commonly owned site or parcel of property 11 reduces losses in the system 10, as the compressed air does not have to travel long distances and facilitates immediate repairs, if and when the system 10 is damaged or experiences a failure, that may be the result of typical use. In the preferred embodiment, the recuperator 30, the exhaust piping system 48, the third underground cavern 28 and the vessel 26 are each also located on the same commonly owned site or parcel of property 11. Specifically, the first, second and third caverns 12, 14, 28 are preferably located immediately below or underground relative to the air compressor 16 and the electric generating mechanism, which are preferably located generally at ground level on the commonly owned site or parcel of property 11.

The electric generating mechanism 22 of the preferred embodiment includes a generator 40, a low-pressure turbine 42, a high-pressure turbine 44 and the natural gas-fueled combustion chamber 32. The heated, pressurized intake air from the recuperator 30 preferably flows into the combustion chamber 32 for further heating, through the high-pressure turbine 44 to generate electricity and through the low-pressure turbine 42 to generate additional energy by driving the generator 40. The energy from the generator 40 preferably flows into the conventional power grid 20 for use by consumers. The electric generating mechanism 22 is not limited to the inclusion of both the high-pressure and low-pressure turbines 44, 42 and may include a single turbine (not shown) or an alternative mechanism to drive the generator 40. The combustion chamber 32 is also not limited to the preferred natural gas-fueled combustion chamber 32 and may comprise nearly any component that is able to heat the pressurized air to drive the electric generating mechanism 22 and generate electricity with the generator 40.

The preferred multiple cavern energy system 10 also includes the fourth storage cavern or vessel 46. The fourth storage cavern or vessel 46 is preferably in fluid communication with the air compressor 34 through the compressor piping system 25 and with the electric generating mechanism 22 through the generator piping system 24, respectively. The fourth storage cavern or vessel 46 may be mounted at or above ground and preferably operates as a fail-safe vessel if the caverns 12, 14, 28 are being improved or maintained to provide a limited amount of pressurized air to temporarily run the system 10. The fourth storage cavern or vessel 46 is also preferably located on the same site or at the same facility 11 as the air compressor 16 and the electric generating mechanism 22 to provide quick response to electric grid 20 demands and to limit air pressure losses in the compressor piping system 25 and the generator piping system 24. However, the system 10 is not limited to having a specific number of storage caverns 12, 14, 28 and/or vessels 46 and may operate with a single source of pressurized air, be it stored in one of the caverns 12, 14, 28, the vessel 46 or in another storage mechanism. In addition, the storage caverns 12, 14, 28 and/or vessels 46 may be located at a site or facility (not shown) distanced from the air compressor 16 and the electric generating mechanism 22.

The alternative energy generator 18 of the preferred embodiment may include a solar power farm, a wind power farm, a hydroelectric dam, a hydroelectric generator, a biofuel facility or other like alternative, energy sources. The alternative energy generator 18 is preferably utilized to power the compressor 16 to pressurize air for storage and later use or for use, when electric grid 20 draw is at its peak.

In the preferred embodiment, the controller 26 is utilized to control the air compressor 34, the electric generating mechanism 22 and the systems for controlling the generator and compressor piping systems 24, 25. The controller 26 directs the air compressor 34 to compress air using off-peak electricity or alternatively generated electricity from the power grid 20 and preferably directs the electric generating mechanism 22 to generate electricity utilizing the compressed air during peak electricity usage time periods. The system 10 of the preferred embodiment is capable of operating such that the air compressor 34 provides compressed air to the first cavern 12 and the electric generating mechanism 22 generates electricity using compressed air from the second cavern 14 at the same time. For example, the controller 26 may actuate the compressor 16 to operate utilizing power from the off-peak electric grid 20 and/or the alternative energy generator 18, the compressor valve 16a, the first cavern inlet valve 13a, the second cavern outlet valve 15b and the generator valve 22b are actuated to the open position and the first cavern outlet valve 13b and the second cavern inlet valve 15a are actuated to the closed position to generate electricity using the electric generating mechanism 22 using pressurized air from the second storage cavern 14 and to load pressurized air into the first storage cavern 12 at the same time. In this preferred example, the third and fourth cavern inlet valves 29a, 47a and the third and fourth cavern outlet valves 29b, 47b are actuated to the closed position by the controller 26, but are not so limited. For example, the third and fourth cavern inlet valves 29a, 47a may each or individually be actuated to the open position such that the pressure in each of the first, third and fourth storage caverns 12, 28 46 are maintained at the same pressure while the pressurized air from the second storage cavern 14 is utilized to generate electricity. This arrangement is not meant to be limiting and the preferred system 10 may be otherwise operated and controlled by the controller 26 to store pressurized air and generate electricity, as would be understood by one having ordinary skill in the art based on a review of the present disclosure.

The electric generating mechanism 22 of the preferred embodiment is capable of producing at least two hundred Megawatts (200 MW) of power and, in a more preferably is capable of producing at least eight hundred Megawatts (800 MW) of power.

The preferred energy system 10 also preferably includes first, second, third and fourth cavern pressure sensors 50a, 50b, 50c, 50d positioned within the first, second, third and fourth storage caverns or vessels 12, 14, 28, 46 that are in communication with the controller 26. The cavern pressure sensors 50a, 50b, 50c, 50d provide air pressure readings to the controller 26 such that the controller 26 is able to efficiently control the preferred system 10 for producing electric power. For example, the controller 26 may direct pressurized air from the air compressor 16 to the first cavern 12 if a pressure reading from the first cavern pressure sensor 50a indicated the air pressure in the first cavern 12 is lower than the air pressure in any of the other caverns 14, 28, 46. Alternatively, if the a first cavern outlet valve 13b is actuated to the open position such that pressurized air from the first underground cavern 12 is flowing to the electric generating mechanism 22 to generate electricity, the controller 26 may actuate each of the second cavern inlet valve 15a, the third cavern inlet valve 29a and the fourth cavern or vessel inlet valve 47a to the open position such that each of the second, third and fourth caverns or vessels 14, 28, 46 receive pressurized air from the air compressor 16 to equalize the pressure in the second, third and fourth caverns or vessels 14, 28, 46 for storage and later use. The second, third and fourth cavern pressure sensors 50b, 50c, 50d should concurrently provide readings to the controller 26 indicating the second, third and fourth caverns or vessels 14, 28, 46 have the same or a similar air pressure therein.

The controller 26 may also be in communication with additional pressure sensors, such as pressure sensors in the compressor piping system 25, the generator piping system 24, the exhaust piping system 48 or other locations in the system 10 to provide checks and control parameters for the controller 26. In addition, the controller 26 may be in communication with additional sensors (not shown), such as temperature sensors in the an compressor 61, the caverns 12, 14, 28, 26, the electric generating mechanism 22, the recuperator 30, generally at the site 11, to, monitor ambient conditions and otherwise to provide further control parameters to the controller 26. The controller 26 is also preferably in communication with the electric grid 20 to monitor electric demand, draw and other related parameters that permit the controller 26 to react to conditions of the electric grid 20 when operating and controlling the preferred system 10.

The system 10 may further include an exit valve 52 and an exhaust valve 54 associated with the exhaust piping system 48. The exit valve 52 is preferably positioned downstream of the recuperator 30 and upstream of the exhaust or exit pipe 30a to control flow of the exhaust from the preferred system 10. The exit valve 52 may also operate as a flow restriction to efficiently operate the recuperator 30 by controlling the flow of exhaust air through the recuperator 30 to maximize the heat transfer between the exhaust air in the exhaust piping system 48 in the recuperator 30 and the intake air in the generator piping system 24 in the recuperator 30. the exhaust valve 54 is preferably similarly utilized to control the flow of exhaust air flow into the recuperator 30. The exit valve 52 and the exhaust valve 54 are preferably in communication with and under the control of the controller 26 for actuation to and between open and closed positions.

The controller 26 may further be in communication with flow sensors in the compressor, generator and exhaust piping systems 25, 24, 48 to monitor and control the flow of pressurized air and exhaust through the system 10. The controller 26 is not limited to being in communication with the pressure sensors 50a, 50b, 50c, 50d, the temperature sensors and/or the flow sensors, but these sensors are preferred to provide control parameters to the controller 26, such that the controller 26 is able to operate the preferred system 10 in an efficient manner.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the present disclosure.

We claim:

1. An energy system for storing pressurized air and utilizing the pressurized air to generate electricity, the energy system comprising:
a first storage cavern;
a second storage cavern separate from the first storage cavern;
an air compressor in fluid communication with the first and second storage caverns through a compressor piping system, the air compressor configured to provide pressurized air to the first and second caverns through the compressor piping system;
an electric generating mechanism in fluid communication with the first and second storage caverns through a generator piping system, the compressor piping system being separate from the generator piping system;
a combustion chamber in fluid communication with the generator piping system and upstream of airflow relative to the electric generating mechanism, the combustion chamber configured to preheat the pressurized air flowing to the electric generating mechanism;
a controller in communication with the air compressor, the electric generating mechanism, the compressor piping system and the generator piping system, the controller configured to operate the energy system such that the compressor directs compressed air into the first storage cavern through the compressor piping system at the same time the electric generating mechanism generates electricity utilizing at least compressed air from the second cavern; and
a recuperator in fluid communication with the electric generating mechanism through an exhaust piping system, the exhaust piping system including an exhaust and being separate from the generator piping system and the compressor piping system, the recuperator configured to transfer heat energy from exhaust air of the electric generating mechanism to the generator piping system.

2. The energy system of claim 1 wherein the air compressor is driven by at least one of an alternative energy generator and off-peak electrical energy from a power grid.

3. The energy system of claim 1, further comprising:
a third storage cavern being in fluid communication with the air compressor through the compressor piping system and the electric generating mechanism through the generator piping system.

4. The energy system of claim 1, wherein the compressor piping system includes a compressor valve, a first cavern inlet valve and a second cavern inlet valve, the generator piping system including a generator valve, a first cavern outlet valve and a second cavern outlet valve, the controller configured to actuate the compressor, the first cavern inlet, the second cavern outlet and the generator valves to an open position and the first cavern outlet and the second cavern inlet valves to a closed position when the compressor directs compressed air into the first storage cavern at the same time the electric generating mechanism generates electricity, utilizing at least the compressed air from the second cavern.

5. The energy system of claim 1, further comprising:
a storage vessel in fluid communication with the compressor piping system, the storage vessel mounted at a ground level, the first and second storage caverns being comprised of underground caverns.

6. The energy system of claim 1, wherein the first and second storage caverns are located on a site and the air compressor, the electric generating mechanism, the combustion chamber, the controller and the recuperator are located on the same site.

7. The energy system of claim 1, wherein the air compressor is driven by an alternative energy generator selected from the group consisting of a solar farm, a wind farm, a hydroelectric facility and a biofuel facility.

8. The energy system of claim 1, further comprising:
a vessel configured to store pressurized air, the vessel being mounted above ground and the first and second storage caverns being comprised of underground caverns.

9. The energy system of claim 1, further comprising:
a cooling tower in communication with the air compressor and configured to cool the air compressor during operation.

10. The energy system of claim 1, wherein the electric generating mechanism includes a generator, a low-pressure turbine and a high-pressure turbine.

11. The energy system of claim 1, wherein the air compressor includes a compressor and a motor, the motor configured to be driven by an alternate energy generator.

12. The energy system of claim 1, further comprising:
a first cavern pressure sensor associated with the first cavern; and
a second cavern pressure sensor associated with the second cavern, the first and second cavern pressure sensors being in communication with the controller, the controller configured to sense air pressure in the first and second caverns based on communication with the first and second cavern pressure sensors, respectively.

13. An energy system for storing pressurized air and utilizing the pressurized air to generate electricity, the energy system comprising:
a first underground storage cavern;
a second underground storage cavern separate from the first underground storage cavern, the first and second underground storage caverns being located on a commonly owned parcel of property;
an air compressor in fluid communication with the first and second storage caverns through a compressor piping system, the air compressor configured to provide pressurized air to the first and second underground storage caverns through the compressor piping system;
an electric generating mechanism in fluid communication with the first and second underground storage caverns through a generator piping system, the compressor piping system being separate from the generator piping system; and
a controller in communication with the air compressor, the electric generating mechanism, the compressor piping system and the generator piping system, the controller configured to operate the energy system such that the compressor directs compressed air into the first underground storage cavern through the compressor piping system at the same time the electric generating mechanism generates electricity utilizing at least compressed air from the second underground storage cavern, the air compressor and the electric generating mechanism being located on the parcel of property.

14. The energy system of claim 13, wherein the controller is located on the parcel of property.

15. The energy system of claim 13, further comprising:
a recuperator in fluid communication with the electric generating mechanism through an exhaust piping system, the exhaust piping system including an exhaust and being separate from the generator piping system and the compressor piping system, the recuperator configured to transfer heat energy from exhaust air of the electric generating mechanism to the generator piping system.

16. The energy system of claim 13, further comprising:
a combustion chamber in fluid communication with the generator piping system and upstream of airflow relative to the electric generating mechanism, the combustion chamber configured to preheat the pressurized air flowing to the electric generating mechanism.

17. The energy system of claim 13, further comprising:
a first cavern pressure sensor associated with the first cavern; and
a second cavern pressure sensor associated with the second cavern, the first and second cavern pressure sensors being in communication with the controller, the controller configured to sense air pressure in the first and second caverns based on communication with the first and second cavern pressure sensors, respectively.

18. The energy system of claim 13, wherein the electric generating mechanism is comprised of a generator, a combustion chamber, a low-pressure turbine and a high-pressure turbine.

19. The energy system of claim 13, further comprising:
a third underground storage cavern located on the parcel of property, the first, second and third underground storage caverns in communication with the compressor piping system and the generator piping system.

20. The energy system of claim 13, further comprising:
a recuperator in communication with the generator piping system; and
an exhaust piping system having an exhaust, the exhaust piping system being in fluid communication with the electric generating mechanism and being in communication with the recuperator to transfer heat from exhaust gas in the exhaust piping system with the compressed air flowing through the generator piping system.
